(19) United States
(12) Patent Application Publication
(10) Pub. No.: US 2025/0031698 A1
(43) Pub. Date: Jan. 30, 2025

(54) COMBINATIONS OF BIOSTIMULANT COMPOSITIONS

(71) Applicant: Shared-X LLC, Grand Cayman (KY)

(72) Inventor: Jose Antonio de Cote, Miami, FL (US)

(21) Appl. No.: 18/715,625

(22) PCT Filed: Dec. 5, 2022
(86) PCT No.: PCT/US2022/080944

§ 371 Date: May 31, 2024

Related U.S. Application Data
(60) Provisional application No. 63/265,024, filed on Dec. 6, 2021.

(51) Int. Cl. A01N 37/46; A01N 59/06; A01N 65/03; A01P 21/00

(52) U.S. Cl. CPC A01N 37/46; A01N 59/06; A01N 65/03; A01P 21/00

(57) ABSTRACT

Combinations of biostimulants including biostimulant compositions having selected amino acids and oligopeptides derived from legumes by enzymatic hydrolysis and added micronutrients and phytoregulator compositions having L-proline, kaolin, and optionally brown algae is provided.

### INCORPORATION BY REFERENCE

A PCT Request Form is filed concurrently with this specification as part of the present application. Each application that the present application claims benefit of or priority to as identified in the concurrently filed PCT Request Form is incorporated by reference herein in their entireties and for all purposes.

### BACKGROUND

During agricultural crop generation, plants grow under conditions that may be particularly efficient and/or productive. However, some crop plants grow under conditions that present nutrient deficiencies that hinder or prevent healthy, efficient growth. Biostimulants may be used to address nutrient deficiencies of certain plants and other aspects of plant growth, such as by generating energy to combat abiotic stress, and by stimulating natural processes that improve the absorption and assimilation of nutrients, treat abiotic stress, and/or improve agronomic characteristics.

The background description provided herein is for the purposes of generally presenting the context of the disclosure. Work of the presently named inventors, to the extent it is described in this background section, as well as aspects of the description that may not otherwise constitute prior art at the time of filing, are neither expressly nor impliedly admitted as prior art against the present disclosure.

### SUMMARY

One aspect involves a method of applying biostimulants to a plant, the method including: applying one or more biostimulant compositions to a plant at a biostimulant composition application time, such that at least one of the one or more biostimulant compositions includes a hydrolysate of a plant protein; and applying one or more phytoregulators to the plant at a phytoregulator application time, whereby at least one of the one or more the phytoregulators includes L-proline.

In various embodiments, the phytoregulator application time and the biostimulant composition application time are different.

In various embodiments, the phytoregulator application time occurs after the biostimulant composition application time.

In various embodiments, the phytoregulator application time is after flower bud growth. In some embodiments, the phytoregulator application time is between flower bud growth and flowering of the plant.

In various embodiments, applying the one or more biostimulant compositions includes applying a first biostimulant composition at a first time and applying a second biostimulant composition at a second time.

In various embodiments such as any of the above embodiments, applying the one or more phytoregulators to the plant includes applying a first phytoregulator at a third time and applying a second phytoregulator at a fourth time.

In various embodiments, applying the one or more phytoregulators to the plant at the phytoregulator application time includes applying the one or more phytoregulators to flower buds on the plant.

In various embodiments, applying the one or more phytoregulators to the plant at the phytoregulator application time includes applying the one or more phytoregulators by foliar spraying.

In various embodiments such as any of the above embodiments, the biostimulant composition application time or third time or fourth time is after flowering of the plant, or between flowering and fruiting of the plant, or between fruiting of and harvesting the plant.

In various embodiments, at least one of the one or more phytoregulators further includes kaolin. In some embodiments, the kaolin is present in the one or more phytoregulators at a concentration of about 20% to about 70% by weight. In some embodiments, at least one of the one or more phytoregulators further includes brown algae.

In various embodiments, applying the one or more biostimulant compositions to the plant the biostimulant composition application time includes applying the one or more biostimulant compositions to soil or foliage of the plant.

In various embodiments, applying the one or more biostimulant compositions to the plant the biostimulant composition application time includes applying the one or more biostimulant compositions by irrigation or foliar spraying.

In various embodiments, the one or more biostimulant compositions includes two or more free amino acids. In some embodiments, the two or more free amino acids are derived from another plant by enzymatic hydrolysis. In some embodiments, at least one of the two or more free amino acids is one or more of glutamic acid, glycine, and lysine.

In various embodiments, the one or more biostimulant compositions further includes one or more micronutrients and/or macronutrients. In some embodiments, the one or more micronutrients and/or macronutrients include one or more of iron, manganese, boron, molybdenum, zinc, chlorine, sodium, cobalt, potassium, and calcium.

In various embodiments, the L-proline is present in the one or more phytoregulators at a concentration of about 20% to about 70% by weight.

In various embodiments, the one or more biostimulant compositions further includes oligopeptides.

In various embodiments, the hydrolysate of a plant protein is present in the one or more biostimulant compositions at a concentration of about 40% to about 60% lysine by weight.

In various embodiments, the hydrolysate of the plant protein is present in the one or more biostimulant compositions at a concentration of about 10% to about 20% glycine by weight.

In various embodiments, the hydrolysate of the plant protein is present in the one or more biostimulant compositions at a concentration of about 30% to about 40% glutamic acid and glutamine by weight.

In various embodiments, the hydrolysate of a plant protein is present in the one or more biostimulant compositions has a density of about 1 gr/ml to about 1.3 gr/ml.

In various embodiments, the one or more biostimulant compositions further includes one or more phytohormones.

Another aspect involves a biostimulant composition for stimulating growth of a plant including: a phytoregulator including L-proline; a biostimulant composition including a hydrolysate of a plant protein; and packaging that holds the phytoregulator in a first compartment and the biostimulant composition in a second compartment, whereby the phytoregulator and the biostimulant composition are substantially prevented from mixing in the packaging.

In various embodiments, the phytoregulator further includes kaolin.

In various embodiments, the phytoregulator further includes brown algae.

In various embodiments, the L-proline is present in the phytoregulator at a concentration of about 20% to about 70% by weight.

In various embodiments, the hydrolysate of a plant protein is present in the biostimulant composition at a concentration of about 40% to about 60% lysine by weight.

In various embodiments, the hydrolysate of a plant protein is present in the biostimulant composition at a concentration of about 10% to about 20% glycine by weight.

Another aspect involves a method of applying biostimulants to a plant, the method including: applying a first phytoregulator to a plant at a first time, whereby the first phytoregulator includes L-proline; and applying a second phytoregulator to the plant at a second time, whereby the second phytoregulator includes brown algae.

In various embodiments, the method also includes applying a biostimulant composition to the plant at a third time, where the biostimulant composition includes a hydrolysate of a plant protein.

These and other aspects are described further below with reference to the drawings.

### BRIEF DESCRIPTION OF THE DRAWINGS

FIGS. 1A, 1B, 1C, and 1D are schematic illustrations of components of example biostimulant compositions that may be combined in accordance with certain disclosed embodiments.

FIG. 2A is a process flow diagram depicting operations performed in a method performed in accordance with certain disclosed embodiments.

FIG. 2B is a process flow diagram depicting operations performed in a method performed in accordance with certain disclosed embodiments.

FIG. 3 is a process flow diagram depicting operations performed in a method performed in accordance with certain disclosed embodiments.

FIGS. 4A and 4B are schematic illustrations depicting example techniques for applying a biostimulant composition in accordance with certain disclosed embodiments.

FIG. 5 is a schematic illustration of an enzymatic hydrolysis reactor that may be used to perform certain disclosed embodiments.

### DETAILED DESCRIPTION

In the following description, numerous specific details are set forth to provide a thorough understanding of the presented embodiments. The disclosed embodiments may be practiced without some or all of these specific details. In other instances, well-known process operations have not been described in detail to not unnecessarily obscure the disclosed embodiments. While the disclosed embodiments will be described in conjunction with the specific embodiments, it will be understood that it is not intended to limit the disclosed embodiments.

Agricultural crop generation involves consideration of various factors to ensure healthy and productive growth of the crops, including the geographical location and growth conditions. However, crops may encounter various agricultural growth difficulties, including soil contamination, genetic mutations, pests (such as insects), disease (e.g., fungal, bacterial, and viral diseases), disruptive effects of automated techniques (e.g., tilling, planting, harvesting, watering, etc.), and other non-ideal growing conditions such as soil composition, humidity (excessive or very low), temperature (very high or very low), luminosity level (e.g., excess solar luminosity or lack thereof), flooding and/or drought, stress caused by fertilizers, inadequate pollination, excess of soil salts (e.g., minerals), and lack of organic material and/or minerals in the soil.

To help resolve these agricultural growth difficulties, it is useful to use substances that are compatible with the plants and that can assist the plant in its growth and life by providing protection to the plant so the plant can utilize its resources more effectively and/or by inducing functions in the plant to improve its growth in different stages of life.

Provided herein are combinations of biostimulant compositions and phytoregulators. These two components are applied to a plant or soil at different times. In addition, while these two components may be provided in the same or associated packaging, they are often separated from one another or prevented from mixing. In some embodiments, the biostimulant component contains multiple amino acids, and optionally one or more additional nutrients such as micronutrients and macronutrients. The phytoregulator component may contain L-proline and a thermoregulator.

### Definitions

Unless defined otherwise, all technical and scientific terms used herein have the same meaning as commonly understood by one of ordinary skill in the art. The terms presented immediately below are more fully understood by reference to the remainder of the specification. The following descriptions are presented to facilitate understanding of certain embodiments and the complex concepts described herein. These descriptions are not intended to limit the full scope of the disclosure.

“Biostimulant composition” may refer to a composition, which may be a substance or mixture, that supplements or corrects nutritional deficiencies in a plant to improve the function of the plant by stimulating biological processes, improving the availability of nutrients, optimizing the plants' absorption of nutrients; increasing tolerance to abiotic stresses, and/or improving quality aspects of the harvest. “Biostimulant” and “biostimulant composition” may be used interchangeably herein.

“Micronutrient” may refer to a secondary plant nutrient used in smaller amounts for nourishment and growth of a plant. A plant nutrient is secondary if a plant only uses trace amounts of it to sustain life. Examples of micronutrients include iron, manganese, zinc, copper, boron, and molybdenum.

“Macronutrient” may refer to a plant nutrient used in large amounts for nourishment and growth of a plant. Examples of primary macronutrients are nitrogen, phosphorous, and potassium. Examples of secondary macronutrients are magnesium, sulfur, and calcium.

A “peptide” may refer to a linear chain of amino acids linked by amide-type chemical bonds, which are called peptide bonds. Thus, to form peptides, amino acids are linked together forming chains of variable length and sequence. Dipeptides may refer to a linear chain of two amino acids linked by a peptide bond. Tripeptides may refer to a linear chain of three amino acids, and tetrapeptides may refer to a linear chain of four amino acids.

An “oligopeptide” may refer to a peptide having less than 10 amino acids.

“Amino acid profile” may refer to the amounts of the amino acids present in a composition. Amino acid profiles may be qualitative or quantitative. Qualitative amino acid profiles identify which amino acids are present in a composition. Quantitative amino acid profiles refer to the relative amounts of amino acids present in a composition and/or to the absolute amounts of amino acids present in a composition.

“Free amino acid” or “free amino acid component” may refer to an amino acid that is not bound to other amino acids and/or peptides via peptide bonds.

A “primary amino acid component” may refer to an amino acid in a composition that is at least about 1% (w/w) of the total weight of amino acids in a composition. In some embodiments, a primary amino acid component is at least about 10% (w/w) of the total weight of amino acids in a composition.

A “secondary amino acid component” may refer to an amino acid in a composition that has a concentration of less than about 1% (w/w) of the total weight of amino acids in a composition. In some embodiments, a secondary amino acid component has a concentration is greater than about 0.01% and less than 0.7% (w/w) of total weight of amino acids in a composition. In some embodiments, a secondary amino acid component has a concentration that is greater than about 0.01% and less than about 1% (w/w) of total weight of amino acids in a composition.

“Feedstock” may refer to a raw, unprocessed material source that can be processed and/or broken down to generate nutritional components.

“Enzymatic hydrolysis” may refer to a process whereby enzymes are used to facilitate degradation of a feedstock by hydrolytically cleaving bonds in molecules with the addition of the elements of water. Proteases are sometimes used to perform enzymatic hydrolysis on a protein-containing feedstock.

“Phytoregulator” may refer to a composition that aids the plant in managing abiotic stress to maintain and improve its growth, and/or induce or catalyze metabolic pathways in the plant to enhance different stages of the plant's life cycle. In some embodiments, a phytoregulator includes at least L-proline. A phytoregulator may be a type of biostimulant. “Phytoregulator” and “phytoregulator composition” may be used interchangeably herein.

### Biostimulant and Phytoregulator Compositions

Biostimulant compositions and phytoregulator compositions are described herein. During the agricultural growth process, plants spend energy manufacturing certain amino acids that are important for their well-being. Biostimulants can supply these amino acids and allow the plant to redirect its energy to performing other functions. Application of biostimulants may reduce negative impacts of biotic stressors as well as abiotic stressors and help correct amino acid, micronutrient, and/or macronutrient deficiencies in the plant. The amino acids of a biostimulant composition have an amino acid profile. That profile may be based, at least in part, on an initial feedstock used to make the biostimulant composition.

It has been observed that some biostimulant compositions, such as those derived from rice, do not have an amino acid profile that matches the needs of some plants growing under some conditions. Additionally, some biostimulant compositions are created using acid hydrolysis, which often destroys certain nutrients and/or amino acids in the feedstock, which can generate free amino acids that may be useful to a plant. While animal derived biostimulants may be generated, such biostimulant compositions lack some components such as phytohormones that are beneficial for plant growth. Further, it is generally more difficult to break down proteins from animal feedstock than from plant feedstock. Some biostimulant compositions may also not be suitable because of synthesis difficulties, lack of efficiency in generating the composition, cost of production, and environmental condition limitations.

Biostimulant compositions disclosed herein may include one or more components that act as a secondary metabolite. Certain disclosed biostimulant compositions include oligopeptides that may bioencapsulate micronutrients and/or macronutrients. In certain embodiments, biostimulant compositions are produced from feedstocks that generate an amino acid profile suitable for plants of many types.

Some feedstocks that may be used have organic origin that have traditionally been considered directly as waste, or at most, are considered low added value materials. These different agro-industrial by-products have properties that give them great potential for application in the agricultural biotechnology industry.

These starting materials are not easily usable, as they are not accessible or available. For example, its high insolubility, mainly, makes its use difficult. However, enzyme technology, with extraction and/or modification processes, can convert these organic materials into new products with greater functionality, due to the concentration of active principles, and better application technological properties (increased solubility and decreased molecular size of its components).

Amino acids generated from feedstock may include free amino acids, amino acids in forming peptides, and amino acids in a protein. Free amino acids are derived from protein hydrolysis and are not bound to any other amino acids through peptide bonds. Due to the low molecular weight of free amino acids, plants are able to assimilate free amino acids quickly and their effects on plant metabolism are more defined. Therefore, free amino acids can be important in plant nutrition. Of note, when two or more amino acids are joined together (by a peptic bond), they form a peptide. The longer the length of the peptide (more amino acids attached), the more difficult will be the direct assimilation by plants. Lastly, amino acids may be present in a protein. The union of the different polypeptide chains forms a protein. The structural units of proteins are the amino acids joined in a sequence and the characteristic order for each type of protein. Free amino acids and some low molecular weight peptides are useful as products applied to plants. The percentage of each type of amino acids depends on the type of hydrolysate and the origin of the proteins (animal or vegetable), and with it, the quality of the final product.

In certain embodiments, the feedstock contains plant material such as material from a carob plant, a peanut plant, a lupin plant, a soybean plant, a rice plant, or the like. Sources that have a high concentration of vegetable protein can be used in various embodiments. When biostimulant compositions are produced from plant feedstock, acid hydrolysis is not used. Some disclosed biostimulant compositions are produced by enzymatic hydrolysis of plant feedstock.

Biostimulant compositions can provide nutrition or energy to the plant, with or without added micronutrients and macronutrients. This can help the plant store extra energy for reproduction.

Biostimulants may include two or more amino acids and optionally one or more micronutrients. Biostimulant compositions have amino acid profiles and oligopeptide profiles. Biostimulant compositions in accordance with certain disclosed embodiments are derived from feedstock that includes a plant-based protein source. Plant-based protein sources may be selected based on their high organic matter content. These by-products have been selected by virtue of their high organic matter content, mainly proteins, and have been characterized to carry out enzymatic hydrolysis processes, obtaining said biostimulant products. Through hydrolytic processes, the functional properties of organic matter contained in agro-industrial organic by-products has been modified, which provides them with a greater capacity for agricultural application, by increasing their bioavailability.

Either or both of the amino acids and oligopeptides may originate from a plant-based protein source. Some biostimulants contain other components from a plant source such as secondary metabolites, phytohormones, micronutrients, and/or macronutrients. Certain biostimulant compositions described herein are in liquid form or have components that are suspended in liquids. Certain biostimulant compositions described herein are in solid form or have solid components.

Some plant-based protein sources include but are not limited to plant material from the Fabaceae and/or Leguminosae family. Particular examples of plant-based protein sources include plant material from the Ceratonia genus, the Arachis genus, the Lupinus genus, the Glycine genus and the Pisum genus. For example, carob germ or carobs (Ceratonia siliqua) may be a suitable plant-based protein source. Peanuts (Arachis hypogaea) may also be a suitable plant-based protein source. Tarwi (Lupinus mutabilis) may also be a suitable plant-based protein source. Soybean (Glycine max) may also be a suitable plant-based protein source. Peas (Pisum sativum) may also be a suitable plant-based protein source. Other suitable genera that may provide a protein source include but are not limited to Astragalus, Acacia, Indigofera, Crotalaria, and Mimosa.

Some plant-based protein sources may be from the Euphorbiaceae family. An example genus from this family is the Plukenetia genus. Plukenetia volubilis, or sacha inchi, is a perennial plant that is native to tropical South America. Plukenetia volubilis may also be a suitable plant-based protein source as it may have significant protein content as well as omega-3 fatty acids, omega-6 fatty acids, and omega-9 fatty acids.

Some plant-based protein sources may be from the Poucede family. One example genus from this family is the Oryza genus. For example, rice may be a suitable plant-based protein source.

In various embodiments, parts of a plant may be used as the plant-based protein source. Example sources include but are not limited to roots, stems, husks, leaves, and seeds. In certain embodiments, plant feedstock is used with little or no preparation other than harvesting and optionally storing and/or milling. In some embodiments, plant feedstock is subject to a post-harvest process such as high temperature drying, oil extraction, or similar process. In peanut sources, after oil extraction, the remaining dry “cake” is used as feedstock. In carob sources, the whole seed with the husk is dried and milled to form the feedstock. In lupine sources, the beans are dried and milled to form the feedstock.

In some embodiments, the plant-based protein source may have at least about 60% protein content by weight of the prepared feedstock (such as dry cake of peanut feedstock), or at least about 50% protein content by weight, or at least about 30% protein content by weight.

Biostimulant compositions have an amino acid profile. The amino acid profile is different depending on the starting raw material and the hydrolysis conditions. Additionally, some raw materials will generate different peptide profiles, and some peptide profiles (oligopeptides and/or polypeptides) have greater or lesser beneficial properties such as nutrient, antimicrobial, and antibacterial capacity. When controlled enzymatic hydrolysis of proteins is carried out, a balance is obtained between amino acids in free form and in peptides, which gives the hydrolysate a significant nutritional role as a biostimulant, due to its ability to stimulate the growth and development of plants and crops, as well as increase and enhance the microbiological activity of the soil. The amino acids and the low molecular weight peptides that make them up are nutritious substances that are easily absorbed and assimilated by plants, both by foliar and root routes, and can be transported to the plant's organs, such as buds, flowers, fruits.

Various types of amino acids may be present in the biostimulant composition. An amino acid profile may be characterized by relative amounts or concentrations of individual amino acids (e.g., proline, alanine, arginine) and/or by the relative amounts or concentrations of classes or types of amino acids.

In some embodiments, amino acids may be non-proteinogenic amino acids. In some embodiments, amino acids may be proteinogenic amino acids. For example, in some embodiments, any one or more of the following types of amino acids are present: aliphatic amino acids, aromatic amino acids, non-polar and neutral amino acids, polar and neutral amino acids, acidic and polar amino acids, and basic and polar amino acids. The amino acids in a biostimulant composition may be proteinogenic or non-proteinogenic (e.g., taurine and ornithine). A biostimulant composition may have at least one of the following amino acids at greater than a trace concentration: aspartic acid with asparagine, glutamic acid with glutamine, glycine, serine, threonine, histidine, tyrosine, arginine, alanine, methionine, valine, tryptophan, phenylalanine, asparagine, glutamine, isoleucine, leucine, proline, hydroxyproline, ornithine, and taurine. In some embodiments, the biostimulant composition includes at least glycine and lysine. In some embodiments, the biostimulant includes at least glutamic acid, glutamine, glycine, and lysine.

In various embodiments, glutamine, histidine, hydroxyproline, methionine, omithine, proline, taurine, tyrosine, aspartic acid and asparagine, arginine, asparagine, phenylalanine, serine, tryptophan, valine, isoleucine, alanine, leucine, and threonine may be secondary amino acid components. In various embodiments, lysine, glycine, and glutamic acid and glutamine may be primary amino acid components.

In some embodiments, the free amino acid component of a biostimulant composition includes (a) one or more primary amino acid components selected from the group consisting of lysine, glycine, and glutamic acid and glutamine, and (b) one or more secondary amino acid components selected from the group consisting of glutamine, histidine, hydroxyproline, methionine, omithine, proline, taurine, tyrosine, aspartic acid and asparagine, arginine, asparagine, phenylalanine, serine, tryptophan, valine, isoleucine, alanine, leucine, and threonine. In some embodiments, the free amino acid component of a biostimulant composition includes (a) one or more primary amino acid components selected from the group consisting of lysine, glycine, and glutamic acid and glutamine, and (b) one or more secondary amino acid components selected from the group consisting of alanine, leucine, and threonine. In some embodiments, the free amino acid component of a biostimulant composition includes (a) one or more primary amino acid components selected from the group consisting of lysine, glycine, and glutamic acid and glutamine, and (b) one or more secondary amino acid components selected from the group consisting of tyrosine, aspartic acid and asparagine, arginine, asparagine, phenylalanine, serine, tryptophan, valine, and isoleucine.

In various embodiments, the free amino acid component of a biostimulant composition has less than about 0.1% histidine, less than about 0.1% methionine, less than about 0.1% glutamine, less than about 0.1% proline, less than about 0.1% hydroxyproline, less than about 0.1% omithine, less than about 0.1% taurine by weight, or any combination of these. In some embodiments, the free amino acid component of a biostimulant composition has less than about 0.1% histidine by weight, or about 0.01% to about 0.1% histidine by weight of the total weight of free amino acid components in the biostimulant composition. In some embodiments, the free amino acid component of a biostimulant composition has less than about 0.1% methionine by weight of the total weight of free amino acid components in the biostimulant composition, or about 0.01% to about 0.1% methionine by weight of the total weight of free amino acid components in the biostimulant composition. In some embodiments, the free amino acid component of a biostimulant composition has less than about 0.1% glutamine by weight of the total weight of free amino acid components in the biostimulant composition, or about 0.01% to about 0.1% glutamine by weight of the total weight of free amino acid components in the biostimulant composition. In some embodiments, the free amino acid component of a biostimulant composition has less than about 0.1% proline by weight of the total weight of free amino acid components in the biostimulant composition, or about 0.01% to about 0.1% proline by weight of the total weight of free amino acid components in the biostimulant composition. In some embodiments, the free amino acid component of a biostimulant composition has less than about 0.1% hydroxyproline by weight of the total weight of free amino acid components in the biostimulant composition, or about 0.01% to about 0.1% hydroxyproline by weight of the total weight of free amino acid components in the biostimulant composition. In some embodiments, the free amino acid component of a biostimulant composition has less than about 0.1% omithine by weight of the total weight of free amino acid components in the biostimulant composition, or about 0.01% to about 0.1% omithine by weight of the total weight of free amino acid components in the biostimulant composition of the total weight of free amino acid components in the biostimulant composition. In some embodiments, the free amino acid component of a biostimulant composition has less than about 0.1% taurine by weight of the total weight of free amino acid components in the biostimulant composition, or about 0.01% to about 0.1% taurine by weight of the total weight of free amino acid components in the biostimulant composition.

In some embodiments, about 0.01% to about 0.3% of the free amino acid components in the biostimulant composition is aspartic acid and asparagine by weight. In some embodiments, the free amino acid component of a biostimulant composition has about 0.01% to about 0.2% tyrosine by weight.

In various embodiments, the free amino acid component of a biostimulant composition has about 0.1% to about 0.5% of each of serine, arginine, isoleucine, valine, tryptophan, phenylalanine, and asparagine by weight. In some embodiments, the free amino acid component of a biostimulant composition has about 0.1% to about 0.5% serine by weight of the total weight of free amino acid components in the biostimulant composition. In some embodiments, the free amino acid component of a biostimulant composition has about 0.1% to about 0.5% arginine by weight of the total weight of free amino acid components in the biostimulant composition. In some embodiments, the free amino acid component of a biostimulant composition has about 0.1% to about 0.5% valine by weight of the total weight of free amino acid components in the biostimulant composition. In some embodiments, the free amino acid component of a biostimulant composition has about 0.1% to about 0.5% tryptophan by weight of the total weight of free amino acid components in the biostimulant composition. In some embodiments, free amino acid component of a the biostimulant composition has about 0.1% to about 0.5% phenylalanine by weight of the total weight of free amino acid components in the biostimulant composition. In some embodiments, the free amino acid component of a biostimulant composition has about 0.1% to about 0.5% asparagine by weight of the total weight of free amino acid components in the biostimulant composition. In some embodiments, the free amino acid component of a biostimulant composition has about 0.1% to about 0.5% isoleucine by weight of the total weight of free amino acid components in the biostimulant composition.

In various embodiments, the free amino acid component of a biostimulant composition has about 0.3% to about 0.7% of each of threonine, alanine, and leucine by weight. In some embodiments, the free amino acid component of a biostimulant composition includes about 0.3% to about 0.7% threonine by weight of the total weight of free amino acid components in the biostimulant composition. In some embodiments, the free amino acid component of a biostimulant composition includes about 0.3% to about 0.7% alanine by weight of the total weight of free amino acid components in the biostimulant composition. In some embodiments, the free amino acid component of a biostimulant composition includes about 0.3% to about 0.7% leucine by weight of the total weight of free amino acid components in the biostimulant composition.

In various embodiments, the free amino acid component of a biostimulant composition has mostly lysine, or about 50% or more lysine, by weight of the total weight of free amino acid components in the biostimulant composition. In various embodiments, the free amino acid component of a biostimulant composition includes mostly glycine, glutamic acid and glutamine, and lysine. In some embodiments, about 30% to about 40% of the free amino acid component of a biostimulant composition is glutamic acid and glutamine. In some embodiments, about 10% to about 20% of the free amino acid component of a biostimulant composition is glycine. In some embodiments, about 40% to about 60% of the free amino acid component of a biostimulant composition is lysine.

The biostimulant composition may include alpha amino acids. The biostimulant composition may include L-alpha amino acids. The biostimulant composition may include basic amino acids. The biostimulant composition may include aliphatic amino acids. The biostimulant composition may include charge-neutral polar amino acids.

The biostimulant composition may include one or more oligopeptides. An oligopeptide may facilitate delivering nutrients to plants and/or moving nutrients within plants.

The biostimulant composition may optionally include one or more non-amino acid and non-peptide components from the plant-based protein source. Examples of such additional plant-based components include phytohormones and secondary metabolites. Example phytohormones include cytokinins, abscisic acid, jasmonates, auxins, and phenolics. Example cytokinins include but are not limited to trans-zeatin riboside (tZR), dihydrozeatin riboside (DZR), cis-zeatin (cZ), cis-zeatin riboside (cZR), isopentenyl adenine (IP), isopentenyl adenosine (iPR), 2-methylthio zeatin (MeS-Z), and 2-methylthio isopentenyl adenine (MeS-iP). Example abscisic acids include abscisic acid (ABA), phaseic acid (PA), dihydrophaseic acid (DPA), and 9-hydroxy-ABA (9OH-ABA). Example jasmonates include jasmonic acid (JA) and jasmonic acid isoleucine (JA-Ile). Example auxins include indole-3-acetic acid (IAA), oxo-indole-3-acetic acid (OxlAA), and indole-3-acetamide (IAM). Example phenolics include salicylic acid (SA) and phenylacetic acid (PAA).

In some embodiments, the concentration of one or more cytokinins in the composition is about 0.5 pmol/ml to about 15 pmol/ml. In some embodiments, the concentration of tZR is about 0.1 pmol/ml to about 0.4 pmol/ml. In some embodiments, the concentration of DZR is about 0.5 pmol/ml to about 1.2 pmol/ml. In some embodiments, the concentration of cZ is about 6 pmol/ml to about 8 pmol/ml. In some embodiments, the concentration of cZR is about 1 pmol/ml to about 2 pmol/ml. In some embodiments, the concentration of iP is about 10 pmol/ml to about 15 pmol/ml. In some embodiments, the concentration of iPR is about 1 pmol/ml to about 2 pmol/ml. In some embodiments, the concentration of MeS-Z is about 4 pmol/ml to about 6 pmol/ml. In some embodiments, the concentration of MeS-iP is about 0.5 pmol/ml to about 0.1 pmol/ml.

In one example, the concentration of tZR is about 0.2 pmol/ml. In one example, the concentration of DZR is about 1 pmol/ml. In one example, the concentration of cZ is about 8 pmol/ml. In one example, the concentration of cZR is about 2 pmol/ml. In one example, the concentration of iP is about 14 pmol/ml. In one example, the concentration of iPR is about 1 pmol/ml. In one example, the concentration of MeS-Z is about 5 pmol/ml. In one example, the concentration of MeS-iP is about 1 pmol/ml.

In some embodiments, the concentration of certain ABAs may range from about 0.1 pmol/ml to about 2800 pmol/ml. In some embodiments, the concentration of ABA is about 3 pmol/ml to about 5 pmol/ml. In some embodiments, the concentration of PA is about 0.1 pmol/ml to about 0.2 pmol/ml. In some embodiments, the concentration of DPA is about 2500 pmol/ml to about 2800 pmol/ml. In some embodiments, the concentration of 9OH-ABA is about 0.5 pmol/ml to about 1.0 pmol/ml.

In some embodiments, the concentration of ABA is about 4 pmol/ml. In some embodiments, the concentration of PA is about 0.1 pmol/ml. In some embodiments, the concentration of DPA is about 2700 pmol/ml. In some embodiments, the concentration of 9OH-ABA is about 0.7 pmol/ml.

In some embodiments, the concentration of certain jasmonates may range from about 0.1 pmol/ml to about 3 pmol/ml. In some embodiments, the concentration of JA is about 2 pmol/ml to about 3 pmol/ml. In some embodiments, the concentration of JA-Ile is about 0.1 pmol/ml to about 0.4 pmol/ml.

In one example, the amount of JA is about 3 pmol/ml. In one example, the amount of JA-Ile is about 0.3 pmol/ml.

In some embodiments, the content of certain auxins may range from about 3 pmol/ml and about 20 pmol/ml. In some embodiments, the amount of IAA is about 15 pmol/ml to about 20 pmol/ml. In some embodiments, the amount of OxIAA is about 4 pmol/ml to about 5 pmol/ml. In some embodiments, the amount of IAm is about 3 pmol/ml to about 5 pmol/ml.

In some embodiments, the amount of IAA is about 18 pmol/ml. In some embodiments, the amount of OxIAA is about 5 pmol/ml. In some embodiments, the amount of IAM is about 5 pmol/ml.

In some embodiments, the content of certain phenolics is about 150 pmol/ml to about 50000 pmol/ml. In some embodiments, phenolics are the majority phytohormone of all phytohormones in the biostimulant composition. In some embodiments, the amount of SA is about 150 pmol/ml to about 200 pmol/ml. In some embodiments, the amount of PAA is about 40000 pmol/ml to about 50000 pmol/ml.

In some embodiments, the amount of SA is about 182 pmol/ml. In some embodiments, the amount of PAA is about 46000 pmol/ml.

In some embodiments, the portion of the biostimulant composition having phytohormones may be predominantly abscisic acids and phenolics. In some embodiments, phenolics are the majority component of phytohormones in a biostimulant composition.

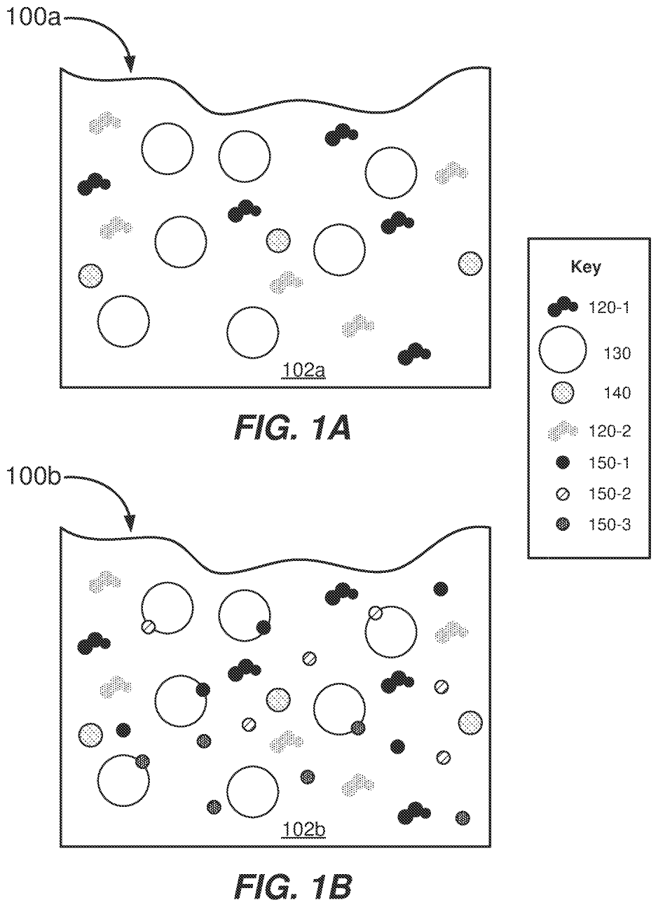

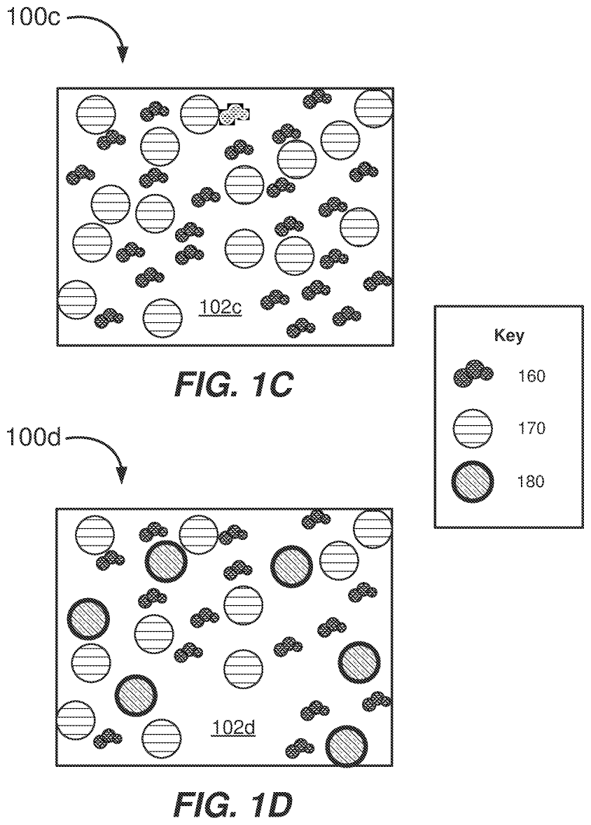

FIG. 1A shows an example schematic illustration of components of a biostimulant composition with components suspended in a liquid in accordance with certain disclosed embodiments. FIG. 1A includes composition 100a having a liquid 102a with suspended components. Suspended components include various types of free amino acids which are depicted as a first type of amino acid 120-1 and a second type of amino acid 120-2. Although two types are depicted in this figure, it will be understood by a person of skill in the art that many types of free amino acids may be in the liquid 102 depending on the amino acid profile, and that the relative concentrations of the free amino acids may vary. Liquid 102a also includes macronutrient 140. Although one type of macronutrient are depicted in this figure, it will be understood by a person of skill in the art that more or fewer types of macronutrients may be presented in the composition 100a. In various embodiments, calcium or potassium may be macronutrient 140. In some embodiments, some macronutrients 140 may be derived from the plant-based protein source. In some embodiments, some macronutrients 140 may be subsequently added to the liquid 102. Liquid 102 also includes oligopeptides 130 which may bioencapsulate micronutrients (not shown) which may be added or derived from the plant-based protein source and such macronutrients 140 help facilitate delivery of micronutrients to parts of a plant.

FIG. 1B shows another example schematic illustration of components of a biostimulant composition with components suspended in a liquid in accordance with certain disclosed embodiments. FIG. 1B includes composition 100b having a liquid 102b with suspended components. Suspended components include various types of free amino acids which are depicted as a first type of amino acid 120-1 and a second type of amino acid 120-2. Although two types are depicted in this figure, it will be understood by a person of skill in the art that many types of free amino acids may be in the liquid 102b depending on the amino acid profile, and that the relative concentrations of the free amino acids may vary. Liquid 102b also includes micronutrients 150-1, 150-2, and 150-3. Liquid 102b also includes macronutrient 140. Although three types of micronutrients and one type of macronutrient are depicted in this figure, it will be understood by a person of skill in the art that more or fewer types of micronutrients and more or fewer types of macronutrients may be presented in the composition 100b. In various embodiments, manganese, boron, zinc, and mixtures of zinc and manganese may be one or more of micronutrients 150-1, 150-2, and 150-3. In some embodiments, only one type of micronutrient (e.g., manganese, boron, or zinc) is present. In some embodiments, mixtures of micronutrients (e.g., zinc and manganese) are present. In various embodiments, calcium or potassium may be macronutrient 140. In some embodiment, only one type of macronutrient is added and no additional micronutrients 150-1, 150-2, or 150-3 are added, but some micronutrients from the original feedstock itself may be present. In some embodiments, some micronutrients 150-1, 150-2, and 150-3 and/or macronutrients 140 may be derived from the plant-based protein source. In some embodiments, some micronutrients 150-1, 150-2, and 150-3 and/or macronutrients 140 may be subsequently added to the liquid 102b. Liquid 102b also includes oligopeptides 130 which may bioencapsulate micronutrients 150-1, 150-2, and 150-3 to help facilitate delivery of micronutrients 150-1, 150-2, and 150-3 to parts of a plant.

Biostimulant compositions may include nutrients such as micronutrients and/or macronutrients, some of which are from the plant-based protein source, and some of which are added to the biostimulant composition to enhance the functions of the biostimulant composition.

Example nutrients include but are not limited to calcium, sulfur, magnesium, carbon, oxygen, hydrogen, iron, manganese, boron, molybdenum, zinc, chlorine, sodium, cobalt, and silicon. Examples of micronutrients include iron, manganese, zinc, copper, boron, silicon, and molybdenum. The concentration of each micronutrient including both added micronutrients and existing micronutrients from the plant-based protein source, in the biostimulant composition may be about 1% to about 15%. Macronutrients include nitrogen, phosphorous, potassium, and calcium. The concentration of each macronutrient including both added macronutrients and existing macronutrients from the plant-based protein source, in the biostimulant composition may be about 1% to about 15%, or about 5%.

In specific examples in this paragraph, nitrogen content is from the raw feedstock; no additional nitrogen is added to form the biostimulant composition. In one example, a biostimulant composition has about 5% boron and about 5% nitrogen. In one example, a biostimulant composition has about 5% manganese and about 2% nitrogen. In one example, a biostimulant composition has about 14% potassium and about 1% nitrogen. In one example, a biostimulant composition has about 6% calcium and about 2% nitrogen. In one example, a biostimulant composition has about 4% zinc, about 4% manganese, and about 2% nitrogen. In one example, a biostimulant composition has about 4% zinc and about 3% nitrogen. In some embodiments, nitrogen in these mixtures is from the raw starting material and is not separately added to the composition.

In various embodiments, the biostimulant composition also includes water. In various embodiments, the amount of water in the biostimulant composition is about 1% to about 99%. In various embodiments, biostimulant compositions having any of the above concentrations of components may be diluted in water, such as about 40% water. Dilution of a biostimulant composition may result in a particular ratio of non-water components to water. In some embodiments, dilution or evaporation is performed to obtain a density of about 1 gr/ml to about 3 gr/ml, or about 1.1 gr/ml or about 1.3 gr/ml. In some embodiments, the biostimulant composition is diluted in water such that concentrations of amino acids present in the biostimulant composition are divided in half.

In various embodiments, the free amino acid component of the biostimulant composition includes about 40 wt % to about 60 wt % lysine by weight of the total weight of free amino acids in the biostimulant composition, and about 1 wt % to about 15 wt % boron. In various embodiments, the free amino acid component of the biostimulant composition includes about 40 wt % to about 60 wt % lysine by weight of the total weight of free amino acids in the biostimulant composition, and about 1 wt % to about 15 wt % manganese. In various embodiments, the free amino acid component of the biostimulant composition includes about 40 wt % to about 60 wt % lysine, and about 1 wt % to about 15 wt % zinc. In various embodiments, the free amino acid component of the biostimulant composition includes about 40 wt % to about 60 wt % lysine by weight of the total weight of free amino acids in the biostimulant composition, and about 1 wt % to about 15 wt % calcium. In various embodiments, the free amino acid component of the biostimulant composition includes about 40 wt % to about 60 wt % lysine by weight of the total weight of free amino acids in the biostimulant composition, and about 1 wt % to about 15 wt % manganese. In various embodiments, the free amino acid component of the biostimulant composition includes about 40 wt % to about 60 wt % lysine by weight of the total weight of free amino acids in the biostimulant composition, about 1 wt % to about 15 wt % manganese, and about 1 wt % to about 15 wt % zinc.

In various embodiments, the free amino acid component of the biostimulant composition includes about 40 wt % to about 60 wt % lysine by weight of the total weight of free amino acids in the biostimulant composition, about 30 wt % to about 40 wt % glutamic acid and glutamine, and about 1 wt % to about 15 wt %. In various embodiments, the free amino acid component of the biostimulant composition includes about 40 wt % to about 60 wt % lysine by weight of the total weight of free amino acids in the biostimulant composition, about 30 wt % to about 40 wt % glutamic acid and glutamine, and about 1 wt % to about 15 wt % manganese. In various embodiments, the free amino acid component of the biostimulant composition includes about 40 wt % to about 60 wt % lysine by weight of the total weight of free amino acids in the biostimulant composition, about 30 wt % to about 40 wt % glutamic acid and glutamine, and about 1 wt % to about 15 wt % zinc. In various embodiments, the free amino acid component of the biostimulant composition includes about 40 wt % to about 60 wt % lysine by weight of the total weight of free amino acids in the biostimulant composition, about 30 wt % to about 40 wt % glutamic acid and glutamine, and about 1 wt % to about 15 wt % calcium. In various embodiments, the free amino acid component of the biostimulant composition includes about 40 wt % to about 60 wt % lysine by weight of the total weight of free amino acids in the biostimulant composition, about 30 wt % to about 40 wt % glutamic acid and glutamine, and about 1 wt % to about 15 wt % manganese. In various embodiments, the free amino acid component of the biostimulant composition includes about 40 wt % to about 60 wt % lysine by weight of the total weight of free amino acids in the biostimulant composition, about 30 wt % to about 40 wt % glutamic acid and glutamine by weight of the total weight of free amino acids in the biostimulant composition, about 1 wt % to about 15 wt % manganese, and about 1 wt % to about 15 wt % zinc.

In one example, a 1 Liter (L) biostimulant includes 550 ml of water, and 450 ml of biostimulant composition (e.g., amino acids, oligopeptides, phytohormones, micronutrients, macronutrients, and other components derived from the plant-based protein source) before added micronutrients and/or macronutrients, includes about 14% added water-soluble potassium including potassium that may have been from the plant-based protein source, and has about 10% free amino acids of the total 1 L of biostimulant.

In one example, a 1 L biostimulant includes 550 ml of water, and 450 ml of biostimulant composition (e.g., amino acids, oligopeptides, phytohormones, micronutrients, macronutrients, and other components derived from the plant-based protein source) before added micronutrients and/or macronutrients, includes about 5% added water-soluble boron including boron that may have been from the plant-based protein source, and has about 10% free amino acids of the total 1 L of biostimulant.

In one example, a 1 L biostimulant includes 550 ml of water, and 450 ml of biostimulant composition (e.g., amino acids, oligopeptides, phytohormones, micronutrients, macronutrients, and other components derived from the plant-based protein source) before added micronutrients and/or macronutrients, includes about 6% added water-soluble calcium including calcium that may have been from the plant-based protein source, and has about 10% free amino acids of the total 1 L of biostimulant.

In one example, a 1 L biostimulant includes 550 ml of water, and 450 ml of biostimulant composition (e.g., amino acids, oligopeptides, phytohormones, micronutrients, macronutrients, and other components derived from the plant-based protein source) before added micronutrients and/or macronutrients, includes about 5% added water-soluble manganese including manganese that may have been from the plant-based protein source, and has about 10% free amino acids of the total 1 L of biostimulant.

In one example, a 1 L biostimulant includes 550 ml of water, and 450 ml of biostimulant composition (e.g., amino acids, oligopeptides, phytohormones, micronutrients, macronutrients, and other components derived from the plant-based protein source) before added micronutrients and/or macronutrients, includes about 5% added water-soluble magnesium (e.g., MgO) including magnesium that may have been from the plant-based protein source, and has about 10% free amino acids of the total 1 L of biostimulant.

In one example, a 1 L biostimulant includes 550 ml of water, and 450 ml of biostimulant composition (e.g., amino acids, oligopeptides, phytohormones, micronutrients, macronutrients, and other components derived from the plant-based protein source) before added micronutrients and/or macronutrients, includes about 5% added water-soluble zinc including zinc that may have been from the plant-based protein source, and has about 10% free amino acids of the total 1 L of biostimulant.

In one example, a 1 L biostimulant includes 550 ml of water, and 450 ml of biostimulant composition (e.g., amino acids, oligopeptides, phytohormones, micronutrients, macronutrients, and other components derived from the plant-based protein source) before added micronutrients and/or macronutrients, includes about 4% added water-soluble zinc including zinc that may have been from the plant-based protein source, and about 4% added water-soluble manganese including manganese and has about 10% free amino acids of the total 1 L of biostimulant.

Biostimulant compositions described herein may be packaged in liquid form of bottles of various sizes, including but not limited to 1 L bottles, 5L bottles, 20 L bottles, and 1000 L bottles. Biostimulant compositions may be diluted to any of various levels of dilution.

Another type of substance that may be used to assist the plant in its growth and life is a phytoregulator. A phytoregulator is a type of biostimulant that has a specific application to a phenological stage of the plant. A phytoregulator is a composition that aids the plant in managing abiotic stress to maintain and improve its growth, and/or induce or catalyze metabolic pathways in the plant to enhance different stages of the plant's life cycle, such as by increasing generation of fruit, increasing flowering, improving the qualities of generated fruit, improving the health and viability of seeds in fruit and/or flowers, and other functions. While some phytoregulators may be used independently, the synergistic effect of a particular selection of phytoregulator components may provide a greater benefit to the plant than either component used alone. In some embodiments, phytoregulators may be used with biostimulant compositions, or combinations of phytoregulators may be used with biostimulant compositions, for synergistic improvement in the growth and development of the plant. In some embodiments, phytoregulator compositions are mixtures of processed powders of different sources.

Phytoregulator compositions disclosed herein may enhance or stimulate induction, synchronization, and/or amount of crop flowering. In some embodiments, a phytoregulator acts directly on metabolic and/or physiological pathways associated with flowering and may increase crop yield. Phytoregulator compositions disclosed herein may enhance or stimulate flower induction, sugar content, and ripening of fruits in crops. In some embodiments, a phytoregulator acts directly on metabolic and/or physiological pathways associated with fruiting and may increase crop yield, improve size of fruits, improve color of fruits, and improve brix degrees of fruits. Some phytoregulator compositions described herein may be hormone-free. In some embodiments, phytoregulator compositions may include phytohormones. For example, algae or seaweed may include phytohormones. Phytoregulator compositions may be used on various plants, including but not limited to horticultural crops, strawberries, berry fruits, citrus, pome fruit trees, stone fruit trees, olive trees, grapes, and more.

FIG. 1C provides a schematic illustration of a mixture 100c of powders in a phytoregulator composition in accordance with certain disclosed embodiments. Mixture 100c includes L-proline 160 and kaolin 170.

L-proline amino acid has a secondary amino group alpha to the carboxyl group. L-proline can induce flowering in plants by acting directly on the metabolic flowing channel in a plant. The amount of L-proline may be at least about 20% by weight, or about 40% to about 80% w/w by dry weight. In some embodiments, the amount of L-proline is about 62% w/w. Although L-proline is described herein, other amino acids may be used to supplement L-proline.

Kaolin, white, soft and plastic clay, is composed mainly of fine-grained laminar particles and can regulate temperature of plants by creating a protective film around a plant to protect it from temperature fluctuations. In some embodiments, kaolin can serve as an insecticide or as a protector against fly and mosquito pests. Kaolin can cover crops, reflect ultraviolet and infrared radiation from the sun, and reduce evapotranspiration. Kaolin may reduce stress on a plant, such that when paired with L-proline, the synergistic effect of reducing stress and inducing flowering increases flower production in a plant. Although kaolin is described herein, other clay base products may be used. The amount of kaolin may be at least about 20% by weight, or about 20% to about 60% w/w by dry weight. In some embodiments, the amount of kaolin may be about 38% w/w. In some embodiments, the amount of L-proline, and amount of kaolin are the same by dry weight. In some embodiments, the ratio of dry weight of L-proline to dry weight of kaolin is about 1:1. In some embodiments, the amount of L-proline is about 63% and the amount of kaolin is about 37%. In some embodiments, the amount of L-proline is about 30% to about 80% by weight and the remaining amount of the composition may be kaolin. In some embodiments, the amount of L-proline is about 30% to about 80% by weight and the amount of kaolin is about 20% to about 70% by weight.

In some embodiments, mixture 100c has a density of about 0.3 gr/ml to about 0.6 gr/ml. The pH of mixture 100c may be about 6.5 to about 7.5, or about 7.

Mixture 100c may also include additional components, such as organic nitrogen, organic matter, potassium, calcium, magnesium, iron, manganese, and boron. The amount of organic nitrogen may be about 5% w/w to about 7.5% w/w, or about 7% w/w. The amount of organic matter may be about 30% w/w to about 70% w/w, or about 50% w/w to about 60% w/w, or about 55% w/w. Mixture 100c may also include trace amounts of potassium, calcium, magnesium, iron, manganese, and boron. “Trace amounts” may refer to less than about 1% by dry weight, or about 0.5 ppm to about 120 ppm. The amount of potassium may be about 0.4% w/w to about 0.8% w/w, or about 0.6% w/w. The amount of calcium may be about 0.5% w/w to about 0.10% w/w, or about 0.8% w/w. The amount of magnesium may be about 0.5% w/w to about 0.15% w/w, or about 0.1% w/w. The amount of iron may be about 80 ppm to about 140 ppm, or about 110 ppm. The amount of manganese may be about 3 ppm to about 5 ppm, or about 4 ppm. The amount of boron may be about 0.5 ppm to about 2 ppm, or about 1.7 ppm.

Mixture 100c may be suitable for applying to flowering crops such as, but not limited to, horticultural crops, strawberries, berry fruits, citrus, pome fruit trees, stone fruit trees, olive trees, grapes, and ornamental plants. Mixture 100c may be used for flowering crops that are used for pigments. Mixture 100c may be used for crops during or before flowering. Mixture 100c may be applied to various types of flowering plants even in adverse conditions. Kaolin has thermoregulatory capacity and is particularly suitable for use in environmental conditions having extreme heat, such as in the south of Spain, and is effective in reducing stress generated by the extreme temperature.

FIG. 1D provides a schematic illustration of a mixture 100d of powders in a phytoregulator composition in accordance with certain disclosed embodiments. Mixture 100d includes L-proline amino acids 160, kaolin 170, and seaweed or brown algae 180. One example brown algae that may be used is Luminaria. One example algae that may be used is Ascophyllum nodosum. Brown algae aids in the transportation of sugars and/or carbohydrates from leaves of a plant to the fruit, thereby assisting with ripening and fruit production. This helps produce a higher quality final fruit product. Brown algae may be dried and brought to a powder granulometry. The amount of brown algae that may be present may be at least about 20% by weight, or about 20% w/w to about 50% w/w. In some embodiments, the amount of brown algae is about 30% w/w. Brown algae used in mixture 100d may also have a particular sugar content. In some embodiments, the amount of brown algae is about 33% w/w.

In mixture 100d, the amount of each of L-proline, kaolin, and brown algae is about 20% to about 60% w/w, or about 20% to about 50% w/w. In some embodiments, the amount of L-proline may be about 20% to about 60% w/w, or about 20% w/w to about 50% w/w. In some embodiments, the amount of L-proline is about 30% w/w. The amount of kaolin may be about 20% w/w to about 50% w/w. In some embodiments, the amount of kaolin may be about 30% w/w.

The amount of brown algae may be about 20% to about 60% w/w, or about 20% w/w to about 50% w/w. In some embodiments, the amount of brown algae may be about 30% w/w. In some embodiments, the amount of each of L-proline, kaolin, and brown algae is about 33% w/w. In some embodiments, the amount of L-proline, amount of kaolin, and amount of brown algae are the same by dry weight. In some embodiments, the ratio of dry weight of L-proline to dry weight of kaolin in a mixture with brown algae is about 2:1 to about 1:2. In some embodiments, the ratio of dry weight of kaolin to dry weight of brown algae in a mixture with L-proline is about 2:1 to 1:2. In some embodiments, the ratio of dry weight of L-proline to dry weight of brown algae in a mixture with kaolin is about 2:1 to 1:2. In some embodiments, the ratio of dry weight of L-proline to dry weight of kaolin to dry weight of brown algae is about 1:1:1.

In some embodiments, mixture 100d has a density of about 0.4 gr/ml to about 0.7 gr/ml or about 0.6 gr/ml. The pH of mixture 100d may be about 6.5 to about 8.5, or about 7.

Mixture 100d may be suitable for applying to fruit crops such as, but not limited to, tomatoes, apples, mangoes, avocadoes, berries, and other fruiting crops where flavor, color, and size may be optimized. Mixture 100d may be applied to a crop during fruiting. Mixture 100d may be suitable for use in particular environmental conditions or in geographical areas having certain types of soil. In various embodiments, mixture 100d may be suitable for use in plants that have a specific soil pH.

In both examples of FIGS. 1C and 1D, the mixture is a wettable powder. In some embodiments, the mixture may be suspended in a liquid or mixed in a liquid. The mixture may be provided in a bilaminated bag with a thermo seal that can act as a humidity barrier to protect kaolin, which is hygroscopic. The lamination on the bag may be used as a ultraviolet (UV) barrier. When the packaged mixture is received and ready for use, the mixture may then be modified at the site of application before applying to crops by diluting it in water. Example dilution is about 80 gr to about 100 gr of the wettable powder mixture is added for every about 100 liters of water. L-proline is water soluble, and kaolin may be suspended particles in the water, periodically mixed to ensure homogeneous mixture in the liquid.

In some embodiments, the phytoregulator composition consists essentially of L-proline, and kaolin. In some embodiments, the phytoregulator composition consists essentially of L-proline, kaolin, and seaweed. In some embodiments, the phytoregulator composition consists essentially of L-proline, kaolin, and brown algae. In some embodiments, the phytoregulator composition consists essentially of L-proline, kaolin, and Luminaria. In some embodiments, the phytoregulator composition consists essentially of L-proline, kaolin, and Ascophyllum nodosum.

In some embodiments, at least about 80% to about 90% of the amino acid content in the phytoregulator composition is free L-proline. In some embodiments, at least about 90% of the amino acid content in the phytoregulator composition is free L-proline. In some embodiments, 100% of the amino acid content in the phytoregulator composition is free L-proline.

Certain disclosed phytoregulator compositions may include organic acids and amino acid derivatives and coadjuvants. In some embodiments, kaolin functions as a coadjuvant. Phytoregulator compositions may include nitrogen, organic matter, potassium, calcium, magnesium, iron, and manganese.

Biostimulant and phytoregulator compositions may be combined in various arrangements. In certain embodiments, a biostimulant composition includes two or more biostimulants and/or phytoregulators. Compositions described with respect to FIGS. 1A and/or 1B can be used in combination with wettable mixtures in FIGS. 1C and 1D in certain disclosed embodiments. Using a combination of biostimulant compositions and/or phytoregulator compositions can enable the plant to have increased function, improved efficiency, increased flowering and/or fruiting, improvement of the quality of flowers or fruits, increased reproduction, improved color, and other characteristics. For example, using a combination of a biostimulant composition having an amino acid profile described herein and a phytoregulator having L-proline for inducing flowering and kaolin for thermoregulating the plant by reducing heat-produced stress can have a synergistic effect by allowing the plant to have ample reserves of energy, efficient use of resources because it is not stressed due to heat, and increased production of flowers because the plant is in optimal conditions. This can also then help the plant produce healthy fruits.

### Methods of making Biostimulant and Phytoregulator Compositions and their Packaging

In some embodiments, biostimulant compositions are made by conducting enzymatic hydrolysis of a plant-based protein source and by optionally adding supplemental micronutrients to the composition, either before or after the hydrolysis. The enzymatic hydrolysis converts plant-based protein to free amino acids and oligopeptides.

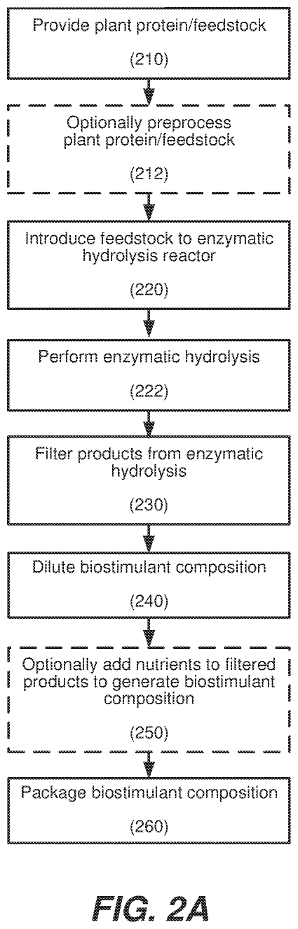

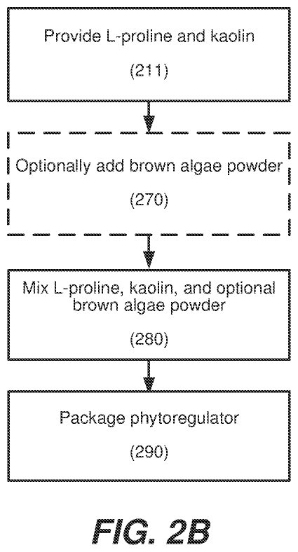

FIG. 2A provides a process flow diagram depicting operations of a method embodiment described herein. In an operation 210, a plant protein and/or feedstock is provided. Example plant sources of feedstock, including plant-based proteins, are described herein and may include but are not limited to any of the following: carobs, peanuts, rice, soybean, Plukenetia volubilis (sacha inchi), and tarwi. The raw plant-based feedstock may be processed (such as ground to a meal), to achieve a feedstock with a particular particle size and water content. In some embodiments, the plant-based feedstock is dried and then milled.

Prior to an operation 220, in an optional operation 212, the pre-processed feedstock (such as a feedstock powder) may undergo pre-hydrolysis processing. Pre-hydrolysis processing may be performed to eliminate polyphenols in vegetable flour because they inhibit the functioning of protease enzymes. Various types of pre-hydrolysis may be performed. Examples include mechanical agitation, addition of water or other liquid, chemical processing such as chemical extraction, sieving, etc. In one example, during pre-hydrolysis processing, polyphenols are extracted from the meal or other feedstock using, e.g., ethanol. Proteases may be mixed with the plant-based feedstock powder. The pH may also be adjusted to make the pH suitable for the enzyme used. In some embodiments, enzymes for conducting enzymatic hydrolysis are added to the feedstock during a preprocessing operation.

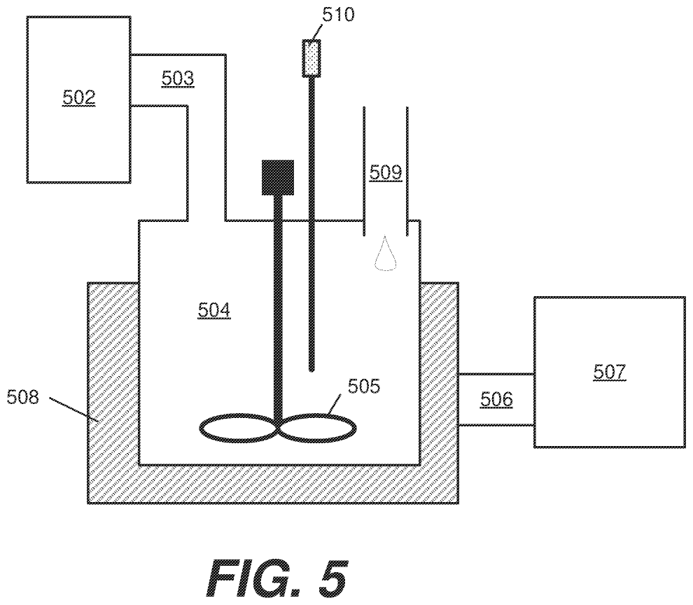

In an operation 220, the feedstock is introduced to an enzymatic hydrolysis reactor. An example is provided in FIG. 5. The enzymatic hydrolysis reactor may include a vessel 504 for containing and/or mixing various components, including processed feedstock and enzymes from a source 502 through inlet 503. In some embodiments, the enzymatic hydrolysis reactor includes a mixing or agitation mechanism such as propeller 505. The reactor also includes pH probe 510 for measuring pH. pH and temperature are controlled in the vessel 504. The pH may be maintained at a pH between 7 and 9, or about 8.5. pH is controlled by including an inlet 509 for dripping acid or base fluids to regulate the pH. For example, 10M of NaOH may be added to maintain a pH of about 8.5. The temperature may be maintained at a temperature between about 55° C. and about 60° C. The temperature may be maintained by using heat sleeve 508. The enzymatic hydrolysis reactor is configured to chemically hydrolyze proteins in the feedstock to produce free amino acids and optionally oligopeptides. Hydrolyzing enzymes are added to the feedstock either before or after the feedstock is introduced to the reactor. Water may be added to the enzymes and/or feedstock either before or after the feedstock is introduced to the reactor. Once, all components are added to the reactor, the temperature and/or pressure of the reactor may be adjusted, and from there, enzymatic hydrolysis proceeds naturally. In some embodiments, the plant-based feedstock includes enzymes, plant-based protein source as a powder, and water.

The type of enzyme used in enzymatic hydrolysis depends on the feedstock. The type of enzyme affects the amount of amino acid obtained from enzymatic hydrolysis. The type of amino acid profile desired for the biostimulant composition depends on the feedstock. Enzymes are capable of breaking protein chains at a particular hydrolysis reaction rate. One enzyme that may be used is a bioprotease that is a purified liquid enzymatic preparation. Some enzymes are widely available and widely used in the detergent production industry, the food industry, and in the textile industry. Example proteases that may be used for enzymatic hydrolysis include but are not limited to aspartic proteases, serine proteases, thiol proteases, and metalloproteases. Example aspartic proteases include but are not limited to pepsin, pepsin A, chymosin, and renin. Example serine proteases include but are not limited to trypsin, chymotrypsin, subtilisin novo, and alcalase. Example thiol proteases include but are not limited to pure papain and bromelain. Proteases may be derived from one or more of the following sources: ox, pig, calf, papaya, pineapple, Bacillus subtilis, Bacillus lichiniformis, Aspergillus niger, Ananas comosus, and Aspergillus oryzae. Proteases may be provided as a mixture of various types of proteases. For example, a protease that is provided for enzymatic hydrolysis may include a mix of an aspartic protease, a metalloprotease, and a serine protease. Example protease mixtures include but are not limited to ProZyme™ available from PRN Pharmacal in Pensacola, FL; Panzyme™ available from Nutra BioGenesis in Park City, Utah Biozyme A™ available from G-Biosciences in St. Louis, MO, and Sanzyme available from Ciba Giegy of Switzerland.

Returning to FIG. 2, in an operation 222, enzymatic hydrolysis is performed. During enzymatic hydrolysis, the following parameters are monitored and controlled: substrate and enzyme concentration, reaction temperature, pH, and stirring speed. The reference substrate (vegetable flour) concentration of milled feedstock weight to water volume is about 10% to about 15% (p/v). In one example, for enzymatic hydrolysis of carob germ, water is added to 300 grams of carob germ having a dry matter content of 55% to a final volume of 1 L such that the resulting mixtures includes a concentration of protein content of 18% (w/v). The enzyme concentration during enzymatic hydrolysis may be about 0.1% to about 0.2% (v/v) or about 0.15% (v/v). Enzymatic hydrolysis may be performed in the reactor at a temperature of about 45° C. to about 55° C. or up to about 60° C. In some embodiments, the mixture may be mixed for a duration of about 2 hours to about 4 hours. The enzymatic hydrolysis may be performed at standard atmospheric pressure. The pH of the enzymatic hydrolysis is determined by the pH suitable for the protease selected. Some enzymes are suitable for a pH of about 7 to about 11, and some can have maximum activity at a pH of about 9. During enzymatic hydrolysis, concentrated NaOH may be added to maintain the pH in such way so as not to substantially increase the volume in the vessel. Stirring speed may be adjusted throughout the enzymatic hydrolysis process depending on the texture of the hydrolysates. For example, when insoluble material solubilizes, stirring speed may be reduced to accommodate the newly soluble texture of the hydrolysates. Enzymatic hydrolysis may be performed until at least about 10% by weight or at least about 15% by weight or at least about 20% by weight of the amount of proteins in the feedstock is converted to free amino acids, oligopeptides, and peptides.

After the hydrolysis process completes, the hydrolyzed mixture may be optionally centrifuged. The centrifuged hydrolyzed mixture is removed from the reactor which may be performed by delivering via outlet 506 of FIG. 5 to filter 507. While proteinaceous material in the feedstock is broken down by proteases, other material in the feedstock is left wholly or partially unreacted. Examples of such unreacted materials include, micronutrients, macronutrients, phytohormones, and the secondary metabolites.

In some embodiments, after hydrolysis, hydrolyzing enzymes are inactivated by, e.g., a temperature shock. Returning to FIG. 2, in an operation 230, the products from the enzymatic hydrolysis are filtered. In some embodiments, two filtrations are carried out (coarse and fine). The first filtration eliminates solids, and the second eliminates further contaminants and solids which are smaller in size. After filtration, in certain embodiments, the product is concentrated to a density of approximately 1.18 g/ml. Finally, in some embodiments, the resulting product is pasteurized to eliminate microorganism contaminants.

In an operation 240, the biostimulant composition is diluted to an amount such as those described above or elsewhere herein. In some embodiments, water is added to the biostimulant composition to achieve a water content of at least about 40% by volume.

In an optional operation 250, nutrients such as micronutrients and/or macronutrients are optionally added to the filtered and diluted products to generate a biostimulant composition. The micronutrients and macronutrients are mixed with the products from the reactor to form a homogeneous mixture, which may prevent particles from sinking to the bottom of the liquid. Mixing may be performed using a paddle or other mechanical component, which may be automatically or manually controlled. Micronutrients include but are not limited to iron, manganese, boron, molybdenum, zinc, chlorine, sodium, and cobalt. One, two, three, or more of the above micronutrients may be added. The amount added may be such that they result in the concentration of each micronutrient including both added micronutrients and existing micronutrients from the plant-based protein source, in the biostimulant composition to be of about 1% to about 15% by weight. Macronutrients include nitrogen, phosphorous, potassium, calcium, sulfur, magnesium, carbon, oxygen, and hydrogen, which may also be added such that the resulting concentration of one or more of the macronutrients is about 1% to about 15% by weight. In some embodiments, macronutrients are not added. In some embodiments, micronutrients are not added. In some embodiments, micronutrients and macronutrients are not added and operation 250 is not performed. In some embodiments, the biostimulant composition already includes micronutrients and/or macronutrients from the plant protein or feedstock.

In an operation 260, the diluted biostimulant composition is packaged. As described above, the diluted biostimulant composition may be packaged in liquid form in to containers (e.g., bottles) of any of various sizes, such as 1 L bottles. Diluted biostimulant composition may be packaged in various forms and in various concentrations.

Phytoregulator compositions described herein may be made by any of various methods. FIG. 2B provides a process flow diagram depicting operations that may be performed in accordance with a certain method embodiment described herein. In operation 211, an amino acid and coadjuvant are provided. An example amino acid is L-proline. An example coadjuvant is kaolin. In some embodiments, these components are dried or ground.

In an operation 270, brown algae is optionally added. Where brown algae is added, brown algae may be processed by being dried, cut, and/or ground into a powder form.

In an operation 280, the amino acid, coadjuvant, and optional brown algae are mixed in a powder form.

In an operation 290, the phytoregulator mixture is packaged. The mixture may be packaged in a wettable powder form in containers. In some embodiments, the phytoregulator mixture is a powder. In some embodiments, the phytoregulator mixture is a liquid solution. In some embodiments, the phytoregulator mixture is a liquid suspension. The phytoregulator mixture may be diluted to any amount of dilution.

In various embodiments, a combination of the phytoregulator mixture in operation 290 is packaged with the diluted biostimulant composition in operation 260 in two or more separate packages with a container housing the two or more separate packages such that the two or more packages can be applied to plants in temporally separated operations during the growth of the plant. The package holding one biostimulant composition may be separate from the package holding a phytoregulator composition such that the two compositions do not mix. In some embodiments, one package is a container holding a liquid, and another package is a container holding a wettable powder. In some embodiments, both packages are containers holding liquids but they are configured in a container such that the liquids do not substantially mix. For example, there may be multiple separate compartments within the container, or a non-porous wall between the two liquids in the container.

Packaging that may be used for containing a wettable powder phytoregulator include pouches, bottles, jars, and boxes. The material used for such packaging include plastics, glass, stainless steel, and paper.

Packaging that may be used for containing a dilute biostimulant composition having amino acid profiles described herein include bottles, jars, pouches, and boxes. The material used for such packaging include plastics, glass, stainless steel, and paper.

In some embodiments, a growth/harvest cycle package may include one or more biostimulant compositions and one or more phytoregulator compositions. In one example, for the growth of tomato plants, packaging may include a box with 52 liters (e.g., 13 applications of 4liters) of biostimulant composition without added micronutrients or macronutrients, 500 grams (e.g., 3 applications of 160 grams) of a phytoregulator having L-proline and kaolin, 16 liters (e.g., 4 applications of 4 liters) of biostimulant composition with added calcium, and 500 grams (e.g., three applications of 160 grams) of a phytoregulator having L-proline, kaolin, and brown algae. Units used in this example are per Hectare.

### Methods of Using Combinations of Biostimulant Compositions

Plants undergo various stages of life in their life cycles: seeds, sprouts or germination, seedlings, adult plants that undergo pre-flowering, flowering, pre-fruiting, and/or fruiting. Plants undergo reproduction and pollination, which may involve growth of flowers and/or fruits, prior to seed spreading. Multiple phytoregulator compositions and/or biostimulant compositions may be used for the plant depending on the stage of life of the plant.

Combinations of biostimulant compositions described herein can be applied to crops or plants in various ways. Prior to applying to crops, a biostimulant composition is diluted. In some embodiments, prior to applying to crops, a phytoregulator composition is mixed with water to dissolve the L-proline and provide a sprayable liquid. In some embodiments, water is added to the biostimulant composition to achieve a water content of at least about 40% by volume.

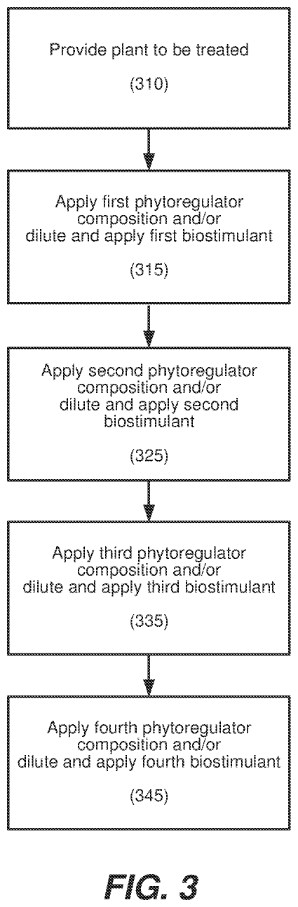

FIG. 3 provides a process flow diagram depicting operations that may be performed in accordance with certain embodiments. In an operation 310, the plant to be treated is located or provided. The plant can be any one of a variety of crops, both ones having intensive short cycles and extensive long cycles. Examples include but are not limited to vegetables, industrial grains, berries, sugar cane, fruit trees, superfoods, and grapes. Biostimulants are not crop specific and are useful for the vast majority of crops grown, including agricultural, medical and horticultural crops. They can be used in organic or conventional farming. Each plant type can utilize a different application regime of biostimulant, to maximize productivity. Depending on the biostimulant composition or phytoregulator composition used, the plant to be treated can be at various stages of its life.

In an operation 315, a first diluted biostimulant or phytoregulator composition is applied to a target crop. In some embodiments, the first composition applied to the target crop before applying any other biostimulant composition is a diluted biostimulant.

When the diluted biostimulant is applied depends on the composition of the biostimulant, the amount of diluted biostimulant applied, and the time in the life cycle of the plant that can take advantage of the benefits of the biostimulant composition. Some plants in different parts of their life cycles can use different amounts of a diluted biostimulant. Some plants in different parts of their life cycles can use different amounts of the same biostimulant. Biostimulant compositions can be applied to various parts of a plant, such as the seed, seedling, stem, leaves, branches, flowers, and fruit, and its surroundings, including the soil.

In some embodiments, biostimulant compositions having an amino acid profile described herein with or without added micronutrients and/or macronutrients may be applied to a plant at seeding up to and including flowering of the plant. Biostimulant compositions may be diluted in hundreds of liters per Hectare before application.

Biostimulant compositions may be applied by irrigation about 1 to about 4 times, or about 3 times, or about 4 times, or more than 4 times depending on the composition and its dilution. Applications of the biostimulant composition by irrigation may involve applying diluted biostimulant where about 1 L to about 5 L per Hectare or about 3 L to about 4L per Hectare of undiluted biostimulant was diluted in a large amount of water (such as hundreds of liters of water, e.g., at least about 200 liters, or at least about 300 liters, or at least about 500 liters of water).

Biostimulant compositions may be applied directly to foliage about 1 to about 4 times, or about 3 times, or about 4 times, or more than 4 times depending on the composition, its dilution, and the crop. Applications of the biostimulant composition by foliage application may involve applying diluted biostimulant where about 0.5 L to about 5 L per Hectare, or about 1.5 L to about 2 L per Hectare, of undiluted biostimulant was diluted in a large amount of water (such as hundreds of liters of water, e.g., at least about 200 liters, or at least about 300 liters, or at least about 500 liters of water).

In some embodiments, biostimulant compositions having an amino acid profile described herein, with or without added micronutrients and/or macronutrients, may be applied to a plant any time between and including fruiting to harvesting the plant. Such compositions may be applied by irrigation about 1 to about 4 times, about 2 to about 3 times, or about 2 times, or about 3 times, or more than 4 times depending on the composition and its dilution. Applications of the biostimulant composition by irrigation may involve applying diluted biostimulant where about 1 L to about 5 L per Hectare of non-diluted biostimulant, or about 3 L to about 4 L per Hectare of undiluted biostimulant was diluted in a large amount of water (such as hundreds of liters of water, e.g., at least about 200 liters, or at least about 300 liters, or at least about 500 liters of water). In some embodiments, applications of diluted biostimulant by irrigation may involve using about 200 L to about 500 L per Hectare of diluted biostimulant. Such compositions may be applied directly to foliage about 1 to about 4 times, or about 3 times, or about 4 times, or more than 4 times depending on the composition and its dilution. Each application by foliage application may include about 0.5 L to about 5 L of undiluted biostimulant, or about 1.5 L to about 2 L of undiluted biostimulant.

When the diluted phytoregulator composition is applied depends on the composition of the phytoregulator and the time in the life cycle of the plant it is applied to as described above. While certain phytoregulator compositions described herein are applied before or after flowering or before or after fruiting, in some embodiments, diluted phytoregulator compositions may be applied at other parts of a plant's life cycle, including but not limited to at seeding, at germination, and at seed development, and diluted phytoregulator compositions may be applied in more than one location on a plant (such as stems, leaves, flowers, fruit, seed pods, etc.) and in more than one stage of plant growth.

Certain phytoregulator compositions may be applied to plants in a flowering phase. For example, a mixture containing L-proline and kaolin without brown algae may be suitable for applying onto plants just before flowering or when one or more flower buds have appeared. In some examples, the earliest time in the growth cycle of a plant to apply a phytoregulator composition having L-proline and kaolin is when the plant initially has flower buds to induce more flowers to grow.

Certain phytoregulator compositions may be suitable for plants in a fruiting phase. They can be used in organic or conventional farming. Each plant type can utilize a different application regime of phytoregulator to maximize productivity. In some examples, the earliest time in the growth cycle of a plant to apply a phytoregulator composition having L-proline, kaolin, and brown algae is when the plant grows its first fruit to aid in the growth, sugar content, and ripening of the fruit.

Diluted phytoregulator compositions suitable for flowering stages or fruiting stages of a plant may be applied to the plant at least twice in the life cycle of the plant, or at most five times in the life cycle of the plant. Phytoregulator compositions inducing flowering may be applied to a plant any time at flowering up to and including fruiting of the plant. Such compositions may be applied about 1 to about 4 times, or about 3 times, or about 4 times, or more than 4 times depending on the composition and its dilution. The amount applied per Hectare is based on the crop and the application method. In some embodiments, each application may involve using about 500 grams of phytoregulator composition, which is diluted in water.

In some embodiments, the composition is applied continuously throughout the flowering or fruiting stage respectively, periodically throughout the flowering or fruiting stage respectively, only before the flowering or fruiting stage respectively, or a combination thereof. Periodic application may have a frequency of daily, or weekly, or biweekly, or monthly, or as frequently as desired depending on the plant life cycle, duration of flowering or fruiting season, and environmental conditions that may modify the plant's life cycle. In various embodiments, the phytoregulator composition may be applied in multiple applications. A first application may be applied when flowering starts, and one or more subsequent applications are applied before, during, and/or after fruiting. In some embodiments, a second application is performed about seven days after the first application. In some embodiments, a third application is performed about ten days after the second application. In some embodiments, fourth and subsequent applications are performed every twenty days after the third and later applications until fruit starts developing. In some embodiments, no more than about five applications are used during flowering. During the flowering stages, the applied composition may include only L-proline and kaolin. When fruit starts developing, a phytoregulator composition may be applied every about ten to about fifteen days until fruit harvesting. The phytoregulator composition applied during fruiting may be different than during flowering. In some embodiments, when fruit starts developing, the phytoregulator composition applied is changed to a composition having L-proline, kaolin, and seaweed (e.g., brown algae). In some embodiments, no more than about five applications may be used during fruiting.

In some embodiments, instead of or in addition to using biostimulant compositions having an amino acid profile described herein from fruiting to harvesting, phytoregulator compositions improving fruiting may be applied to a plant any time at fruiting up to harvesting. Such compositions may be applied about 1 to about 3 times, or about 2 times, or about 3 times, or more than 3 times depending on the composition and its dilution. Such compositions may be applied directly to foliage about 1 to about 4 times, or about 3 times, or about 4 times, or more than 4 times depending on the composition and its dilution.

The diluted phytoregulator composition and/or biostimulant composition may be applied to a plant in a pot, or a plant grown by hydroponics, or a plant grown in an open field. Each of these types of plants may utilize different amounts of phytoregulator composition or biostimulant composition.

The location in which a diluted biostimulant composition is applied may also vary from plant to plant. A diluted phytoregulator composition may be applied to foliage of a plant. Mixtures containing L-proline and kaolin may be applied to inflorescences of a plant. Mixtures containing L-proline, kaolin, and brown algae may be applied to leaves and fruits of a plant.

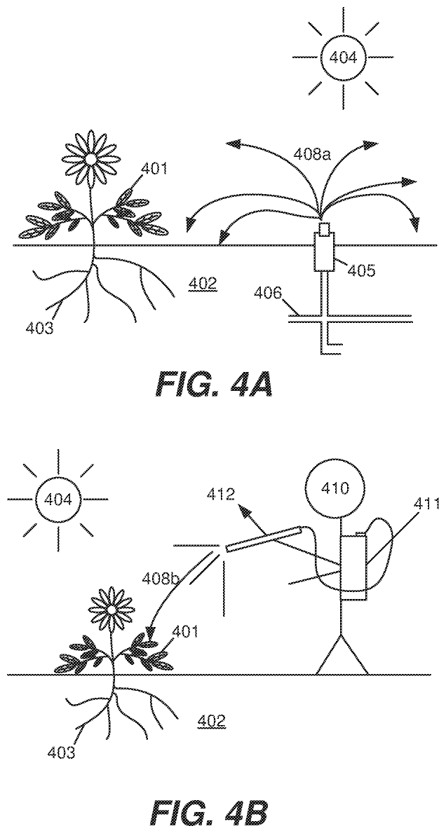

The method of application depends on the biostimulant composition or phytoregulator composition being applied. For example, in some embodiments, for biostimulant compositions derived from plant protein feedstocks with or without micronutrients or macronutrients added, irrigation systems are used, such as shown in the example in FIG. 4A, which includes a schematic diagram of a plant 401 having roots 403 in soil 402 under a light source 404 (in this case, the sun), with an irrigation system having piping 406 and delivery spout 405 whereby the trajectory 408a of a diluted biostimulant composition may be used to apply the diluted biostimulant composition via irrigation.

In some embodiments, diluted biostimulants or phytoregulator compositions are applied directly to a plant, such as to the leaves or the foliage of a plant and may be manually applied by a person. An example is provided in FIG. 4B which is a schematic diagram of a plant 401 having roots 403 in soil 402 under a light source 404 whereby the trajectory 408b of a diluted biostimulant is delivered or sprayed via a mister 412 handled by a human 410 from a container 411 of biostimulant composition. Where the diluted biostimulant composition is applied depends on environmental variables as well. This technique may be used to apply biostimulant compositions derived from plant protein feedstocks with or without micronutrients or macronutrients added, or may be used to apply biostimulant compositions having L-proline, kaolin, and optionally brown algae.

While a mister 412 is depicted in this example, it will be understood that other technologies capable of applying the composition to flowers and fruits may be used, including but not limited to fumigation backpacks and spray booms. Direct application to foliage may be used to allow the composition to be received by the plant through stoma in the leaves. In some embodiments, products may be applied directly to flowers or fruit.

Returning to FIG. 3, in an operation 325, a second phytoregulator composition and/or diluted second biostimulant composition is applied. This may have a composition different from that of the composition applied in operation 315. The combination of the two different phytoregulator and/or biostimulant compositions, as well as the order of application depending on the stage of life of the plant, can have a synergistic improved effect on the plant. For example, the operation 315 may be performed prior to operation 325 in the life cycle of a plant. The second phytoregulator composition and/or diluted second biostimulant composition may be applied using any suitable technique such as those described above with respect to FIGS. 4A and 4B, depending on the composition used.

For example, a phytoregulator used for inducing flowering may be applied to the plant during the flowering stage, a biostimulant composition with or without added micronutrients or macronutrients can be applied to the plant following flowering, and during the fruiting stage, the biostimulant composition may continue to be applied, or a second phytoregulator composition used to improve fruiting (such as one containing L-proline, kaolin, and brown algae) can be used instead of or in addition to the biostimulant composition.

In an operation 335, a third phytoregulator composition and/or diluted third biostimulant composition is optionally applied. This may have a composition different from that of compositions applied in operations 315 or 325, or may have the same composition as one of compositions applied in operations 315 or 325.

In an operation 345, a fourth phytoregulator composition and/or diluted fourth biostimulant composition is optionally applied. This may have a composition different from that of compositions applied in operations 315 or 325 or 335, or may have the same composition as one of compositions applied in operations 315 or 325 or 335.

In one example, a first biostimulant composition is applied, followed by a phytoregulator composition during flowering.

In one example, a diluted biostimulant composition having a particular amino acid profile without added micronutrients or macronutrients as described elsewhere herein is applied and subsequently, a phytoregulator composition having a mixture of L-proline and kaolin that is wetted to form a diluted phytoregulator composition is applied during the flowering stage of a plant.

In one example, the first composition applied is a diluted biostimulant composition having a particular amino acid profile without added micronutrients or macronutrients, followed by a first phytoregulator composition during flowering, followed by a diluted biostimulant composition having a particular amino acid profile with added micronutrients or macronutrients.

In one example, the first composition applied is a diluted biostimulant composition having a particular amino acid profile without added micronutrients or macronutrients, followed by a first phytoregulator composition during flowering, followed by a second phytoregulator composition during fruiting.

In one example, a first biostimulant composition is applied, followed by a first phytoregulator composition during flowering, followed by a second phytoregulator composition during fruiting.

In one example, the first composition applied is a diluted biostimulant composition having a particular amino acid profile without added micronutrients or macronutrients, followed by a first phytoregulator composition during flowering, followed by a diluted biostimulant composition having a particular amino acid profile with added micronutrients or macronutrients.

In one example, the first composition applied is a diluted biostimulant composition having a particular amino acid profile without added micronutrients or macronutrients, followed by a phytoregulator composition during flowering or during fruiting, followed by a diluted biostimulant composition having a particular amino acid profile with added micronutrients or macronutrients.

In one example, the first composition applied is a diluted biostimulant composition having a particular amino acid profile without added micronutrients or macronutrients, followed by a first phytoregulator composition during flowering, followed by a diluted biostimulant composition having a particular amino acid profile with added micronutrients or macronutrients, followed by a second phytoregulator composition during fruiting.

In one example, a first biostimulant composition is applied, followed by a first phytoregulator composition during flowering, followed by a second biostimulant composition, followed by a second phytoregulator composition during fruiting.

In one example, a first biostimulant composition is applied having a particular amino acid profile without added micronutrients or macronutrients, followed by a first phytoregulator composition during flowering, followed by a second biostimulant composition, followed by a second phytoregulator composition during fruiting.

In one example, the first composition applied is a diluted biostimulant composition having a particular amino acid profile without added micronutrients or macronutrients, followed by a phytoregulator composition as a mixture of L-proline and kaolin during flowering, followed by a diluted biostimulant composition having a particular amino acid profile with added micronutrients or macronutrients, followed by L-proline, kaolin, and brown algae during fruiting.

In some embodiments, the first phytoregulator composition and the second phytoregulator composition are the same composition. In some embodiments, the first phytoregulator composition and the second phytoregulator composition are different compositions. In some embodiments, the first phytoregulator composition and the second phytoregulator composition are L-proline and kaolin. In some embodiments, the first phytoregulator composition and the second phytoregulator composition are L-proline, kaolin, and brown algae. In some embodiments, the first phytoregulator composition is L-proline and kaolin, and the second phytoregulator composition is L-proline, kaolin, and brown algae. In some embodiments, the first phytoregulator composition is L-proline, kaolin, and brown algae, and the second phytoregulator composition is L-proline and kaolin.

As is now apparent, various biostimulant and phytoregulator application sequences may be employed. For example, some sequences employ three separate applications to a plant and some employ four separate applications to a plant. The timing of these applications is optionally tied to stages of plant growth such as germination, flowering, and fruiting. Example sequences follow.
1. Initially deliver a biostimulant comprising plant-derived amino acids and peptides
2. Later, such as when flowering starts, deliver a phytoregulator such as one comprising proline
1. Initially deliver a biostimulant comprising plant-derived amino acids and peptides
2. Later, such as when flowering starts, deliver a phytoregulator such as one comprising proline
3. Later, and based on determining that a nutritional deficit, deliver a biostimulant comprising a micro/macronutrient supplement (optionally with plant-derived amino acids and peptides)
1. Initially deliver a biostimulant comprising plant-derived amino acids and peptides
2. Later, such as when flowering starts, deliver a phytoregulator such as one comprising proline
3. Later, and based on determining that a nutritional deficit, deliver a biostimulant comprising a micro/macronutrient supplement (optionally with plant-derived amino acids and peptides)
4. Later, such as when fruiting starts, deliver a different phytoregulator such as one comprising proline and a plant product such as brown algae.
1. Initially deliver a biostimulant comprising plant-derived amino acids and peptides
2. Later, such as when flowering starts, deliver a phytoregulator such as one comprising proline
3. Later, such as when fruiting starts, reapply the phytoregulator.

In one example, the first phytoregulator composition applied is a mixture of L-proline and kaolin that is wetted to form a diluted phytoregulator composition and is applied during the flowering stage of a plant, and subsequently, a diluted biostimulant composition having a particular amino acid profile with added micronutrients or macronutrients described elsewhere herein is applied.

In one example, the first phytoregulator composition applied is a mixture of L-proline, kaolin, and brown algae that is wetted to form a diluted phytoregulator composition and is applied during the fruiting stage of a plant, and subsequently, a diluted biostimulant composition having a particular amino acid profile with added micronutrients or macronutrients described elsewhere herein is applied.

In one example, a diluted biostimulant composition having a particular amino acid profile without added micronutrients or macronutrients as described elsewhere herein is applied followed by applying a first phytoregulator composition having a mixture of L-proline, kaolin, and brown algae that is wetted to form a diluted phytoregulator composition and is applied during the fruiting stage of a plant.

In one example, a first biostimulant composition is applied, followed by a phytoregulator composition during flowering or during fruiting, followed by a second biostimulant composition.

In one example, a first biostimulant composition is applied, followed by a phytoregulator composition during fruiting.

### Conclusion

Although the foregoing embodiments have been described in some detail for purposes of clarity of understanding, it will be apparent that certain changes and modifications may be practiced within the scope of the appended claims. It should be noted that there are many alternative ways of implementing the processes, systems, and apparatus of the present embodiments. Accordingly, the present embodiments are to be considered as illustrative and not restrictive, and the embodiments are not to be limited to the details given herein.

What is claimed is:

1. A method of applying biostimulants to a plant, the method comprising:
applying one or more biostimulant compositions to a plant at a biostimulant composition application time,
wherein at least one of the one or more biostimulant compositions comprises a hydrolysate of a plant protein; and
applying one or more phytoregulators to the plant at a phytoregulator application time,
wherein at least one of the one or more the phytoregulators comprises L-proline.

2. The method of claim 1, wherein the phytoregulator application time and the biostimulant composition application time are different.

3. The method of claim 1, wherein the phytoregulator application time occurs after the biostimulant composition application time.

4. The method of claim 1, wherein the phytoregulator application time is after flower bud growth.

5. The method of claim 4, wherein the phytoregulator application time is between flower bud growth and flowering of the plant.

6. The method of claim 1, wherein applying the one or more biostimulant compositions comprises applying a first biostimulant composition at a first time and applying a second biostimulant composition at a second time.

7. The method of any of claim 1 or 6, wherein applying the one or more phytoregulators to the plant comprises applying a first phytoregulator at a third time and applying a second phytoregulator at a fourth time.

8. The method of claim 1, wherein applying the one or more phytoregulators to the plant at the phytoregulator application time comprises applying the one or more phytoregulators to flower buds on the plant.

9. The method of claim 1, wherein applying the one or more phytoregulators to the plant at the phytoregulator application time comprises applying the one or more phytoregulators by foliar spraying.

10. The method of any of claim 1 or 7, wherein the biostimulant composition application time or third time or fourth time is after flowering of the plant, or between flowering and fruiting of the plant, or between fruiting of and harvesting the plant.

11. The method of claim 1, wherein at least one of the one or more phytoregulators further comprises kaolin.

12. The method of claim 11, wherein at least one of the one or more phytoregulators further comprises brown algae.

13. The method of claim 1, wherein applying the one or more biostimulant compositions to the plant the biostimulant composition application time comprises applying the one or more biostimulant compositions to soil or foliage of the plant.

14. The method of claim 1, wherein applying the one or more biostimulant compositions to the plant the biostimulant composition application time comprises applying the one or more biostimulant compositions by irrigation or foliar spraying.

15. The method of claim 1, wherein the one or more biostimulant compositions comprises two or more free amino acids.

16. The method of claim 15, wherein the two or more free amino acids are derived from another plant by enzymatic hydrolysis.

17. The method of claim 15, wherein at least one of the two or more free amino acids are selected from the group consisting of glutamic acid, glycine, and lysine.

18. The method of claim 1, wherein the one or more biostimulant compositions further comprises one or more micronutrients and/or macronutrients.

19. The method of claim 18, wherein the one or more micronutrients and/or macronutrients are selected from the group consisting of iron, manganese, boron, molybdenum, zinc, chlorine, sodium, cobalt, potassium, and calcium.

20. The method of claim 1, wherein the L-proline is present in the one or more phytoregulators at a concentration of about 20% to about 70% by weight.

21. The method of claim 11, wherein the kaolin is present in the one or more phytoregulators at a concentration of about 20% to about 70% by weight.

22. The method of claim 1, wherein the one or more biostimulant compositions further comprises oligopeptides.

23. The method of claim 1, wherein the hydrolysate of a plant protein is present in the one or more biostimulant compositions at a concentration of about 40% to about 60% lysine by weight.

24. The method of claim 1, wherein the hydrolysate of the plant protein is present in the one or more biostimulant compositions at a concentration of about 10% to about 20% glycine by weight.

25. The method of claim 1, wherein the hydrolysate of the plant protein is present in the one or more biostimulant compositions at a concentration of about 30% to about 40% glutamic acid and glutamine by weight.

26. The method of claim 1, wherein the hydrolysate of a plant protein is present in the one or more biostimulant compositions has a density of about 1 gr/ml to about 1.3 gr/ml.

27. The method of claim 1, wherein the one or more biostimulant compositions further comprises one or more phytohormones.

28. A biostimulant composition for stimulating growth of a plant comprising:
a phytoregulator comprising L-proline;
a biostimulant composition comprising a hydrolysate of a plant protein; and
packaging that holds the phytoregulator in a first compartment and the biostimulant composition in a second compartment,
wherein the phytoregulator and the biostimulant composition are substantially prevented from mixing in the packaging.

29. The biostimulant composition of claim 28, wherein the phytoregulator further comprises kaolin.

30. The biostimulant composition of claim 29, wherein the phytoregulator further comprises brown algae.

31. The biostimulant composition of claim 28, wherein the L-proline is present in the phytoregulator at a concentration of about 20% to about 70% by weight.

32. The biostimulant composition of claim 28, wherein the hydrolysate of a plant protein is present in the biostimulant composition at a concentration of about 40% to about 60% lysine by weight.

33. The biostimulant composition of claim 28, wherein the hydrolysate of a plant protein is present in the biostimulant composition at a concentration of about 10% to about 20% glycine by weight.

34. A method of applying biostimulants to a plant, the method comprising:
applying a first phytoregulator to a plant at a first time,
wherein the first phytoregulator comprises L-proline; and
applying a second phytoregulator to the plant at a second time,
wherein the second phytoregulator comprises brown algae.

35. The method of claim 34, further comprising applying a biostimulant composition to the plant at a third time, wherein the biostimulant composition comprises a hydrolysate of a plant protein.
